(19) United States
(12) Patent Application Publication
(10) Pub. No.: US 2024/0054795 A1
(43) Pub. Date: Feb. 15, 2024

(54) Automatic Vehicle Verification

(71) Applicant: Reby Inc., Walnut, CA (US)

(72) Inventors: Elizabet Bayo Puxan, Barcelona (ES); Eugeni Llagostera Saltor, Barcelona (ES); Xiaolei Song, Barcelona (ES); Akash Kadechkar, Barcelona (ES); Ricard Comas Xanco, Tordera (ES); Julio Gonzalez Lopez, Igualada (ES)

(21) Appl. No.: 17/819,311

(22) Filed: Aug. 12, 2022

(51) Int. Cl. G06V 20/62; G06V 30/19; G06V 30/12; G06V 30/146; G06V 30/14; G06K 7/14; G06K 7/10

(52) U.S. Cl. CPC G06V 20/625; G06V 30/19013; G06V 30/12; G06V 30/1473; G06V 30/1444; G06K 7/1417; G06K 7/10712; G06V 2201/08

(57) ABSTRACT

The present disclosure relates to a system and method for automatic vehicle recognition, based on a smart device. The system mainly includes an image capturing device integrated in the smart device, a data storage to store the images captured by the image capturing device and known identity aspects related to a vehicle allotted to a user, and a License plate processing and matching (LPPM) component to perform recognition process. LPPM component includes an identity aspect detector to detect a portion representing the identity aspect, an image processor to enhance the portion and perform Optical Characters Recognition (OCR) to extract character strings from the portion. The character string is compared against a character string of the known identity aspect to verify the vehicle.

### FIELD OF THE INVENTION

The present disclosure generally relates to vehicle verification. In particular, the present disclosure relates to a system and method implemented on a smart device for automatic vehicle verification process based on at least one identity aspect of the vehicle.

### BACKGROUND OF THE INVENTION

Currently, rental car services, micro-mobility applications, car-pool applications are being developed and are favored by users because such applications and services significantly contribute to convenience and economic factors associated with traveling or commuting. But few services relate to renting a car from a service provider for specific duration or specific distance. And few services relate to sharing seats in the car with fellow co-passengers who are also users of the same service. Few services relate to renting a two-wheeler vehicle or a bicycle that can be picked up from a parking location of the service provider or where that vehicle was left by the previous renter and can be parked upon ride completion at another parking location.

Current services are generally applications that utilize a vehicle management system that maintains a central database of the vehicles deployed in the service, a controller, a plurality of sensors for tracking, verifying and inspecting vehicles, software modules, and a combination thereof to perform one or more management operations, such as verifying the user and allotting them a vehicle, calculating distance traveled or duration of the ride to determine an amount to be paid by the user to the service provider and such, on respective devices of the user and the service provider.

Current vehicle management systems typically require human intervention for operations. For example, the user must pick up the vehicle from a registered location of business and the vehicle must be inspected by an authorized person. When the user wishes to end the trip, the vehicle and other essential trip aspects must be inspected by the authorized person only at an official location. To minimize human intervention, a vehicle recognition and monitoring system is implemented. The vehicle recognition and monitoring system may utilize traffic surveillance cameras, parking location's surveillance cameras, and other cameras, to capture multiple images of the vehicles to determine if any parking violation, ride/drive instructions violation, rental service agreement violation has been accounted for by the user. Such approach may work on car rental services, but not on micro mobility services as these micro-mobility vehicles, such as a scooter, may be left by renters at an unknown location outside of the territory controlled by the rental company at a location where parking of such vehicles is allowed. Additionally, duration between the time when traffic rule violation was committed, and the time of scanning would be sufficient for an authority to raise a violation ticket. Moreover, there would be no indication confirming if the vehicle was wrongfully parked by the user or it was relocated by someone else.

Therefore, current vehicle recognition and monitoring systems that rely on external surveillance components are not effective and cause additional burden of maintaining the infrastructures, particularly for micro-mobility services. To avoid capturing images using external cameras, few systems allow the user to capture images from a smartphone and share with a central processing unit for verification. However, such systems are dependent on a network, such as a wireless communication network or cellular network, to transmit the captured images to the central processing unit. These systems will be of no use if the user is at a location with restrictive, expensive, limited, or no communication network. Even if the user manages to transmit the images to the central processing unit, comparing the images against the entire database to verify the vehicle in question is a time and resource consuming task.

Methods are known that scan a license plate of a shared bicycle to unlock the bicycle if the target license plate matches a license plate number stored in a database.

Methods are also known for detecting if a user does not return a shared car. In general terms, a user is prompted to take an image marker of the shared car if the user is at a car returning network point and the user is out of the network. If the image marker is accepted, the user may return the shared vehicle.

Thus, known methods allow a user to capture images of the vehicle but require transmitting the images to the central unit over a network or return the vehicles at authorized locations. Both requirements are inconvenient as the process is network dependent, and time and resources consuming. Therefore, there is a need for an improved system and method for automatic vehicle verification that avoids the drawbacks of known systems.

### SUMMARY OF THE INVENTION

The present disclosure relates to a system, for automatic vehicle verification using at least one identity feature corresponding to the vehicle, implemented on a smart device. In one exemplary embodiment, the system is configured to employ one or more components of the smart device to operate a method. The system mainly includes, but may not be limited to, an image capturing device, integrated with the smart device, to capture an image of at least a portion of the vehicle. The portion includes at least one identity aspect of the vehicle. The system further includes a data storage to temporarily store the captured images that may also be sent to a central storage for record keeping and at least one known identity aspect of the vehicle. The system further includes a License Plate Processing and Matching (LPPM) Component, to perform image processing and matching. The LPPM includes an identity aspect detector, an image processor, and a verification unit, in one implementation. The identity aspect detector is configured to detect at least one portion of the captured vehicle image. The at least one portion is indicative of the at least one identity aspect of the vehicle. The image processor is configured to implement optical characters recognition (OCR) method and is configured to perform processing of the captured vehicle image, analyzing the at least one portion to identify a character string including characters and symbols representing the at least one identity aspect, and converting the character string into a machine-readable format. The verification unit is configured to verify the vehicle by comparing the machine-readable character string with a character string of the at least one known identity aspect of the vehicle. The verification is carried out on the smart device in real-time without a wireless network.

In one embodiment, the identity aspect is a license plate in human readable format that can be converted into a machine-readable format.

In one embodiment, the identity aspect is a barcode or a quick response (QR) code in a machine-readable format.

In one embodiment, the image processing and matching is carried out by a template matching technique.

In one embodiment, the at least one identity aspect is detected by a self-learning algorithm or human-assisted learning algorithms.

In one embodiment, the at least one identity aspect is detected by a detection module that identifies a plurality of areas indicating presence of the at least one identity aspect. Each of the plurality of areas is processed until the identification aspect is verified.

In one embodiment, if all the plurality of areas are processed and vehicle verification is failed, the system is configured to prompt a user to capture a second image of the vehicle. The second image is processed for vehicle verification.

In one embodiment, the captured vehicle's image is a frame from the real-time video stream.

In one embodiment, the image processing comprises an image correction, an image editing, an image rotating, or a combination thereof.

In one embodiment, the identity aspect detector is based on a classical computer vision algorithm or a deep learning algorithm.

In one embodiment, the deep learning algorithm is configured to detect the shape of a plate representing the at least one identity aspect, a border confining the at least one identity aspect, a plurality of corners of the shapes or the border.

In one embodiment, the system enables a user to pre-store shapes, borders, plates of the at least one known identity aspect into the data storage.

In one embodiment, the comparison between the at least one identity aspect and the at least one known identity aspect is considered based on a confidence score indicative of a probability of correct recognition of confusing characters.

The present disclosure, in one embodiment, relates to a method for automatic vehicle verification using at least one identity feature corresponding to a vehicle. The method is implemented on a smart device, in accordance with one implementation. The method steps include capturing vehicle images by an image capturing device, storing the captured images and at least one known identity aspect of the vehicle in a data storage, detecting at least one identity aspect of the vehicle from the captured vehicle images by an identity aspect detector, processing the captured vehicle image, identifying at least one area of the captured vehicle image that is indicative of the at least one identity aspect, converting content of the at least one area into a machine-readable format, verifying, by a verification unit, the vehicle by comparing the at least one identity aspect with the at least one known identity aspect of the vehicle, wherein the verification is carried out on the smart device in real-time without a wireless network.

### DESCRIPTION OF THE DRAWINGS

FIG. 1 is a block diagram of a system for an exemplary rented car service (RCS) present in the prior art.

FIG. 2 is a block diagram of the smart device with the functional component, in accordance with one embodiment.

FIG. 3 is a block diagram of a system implemented on the smart device for automatic vehicle verification, in accordance with one embodiment.

FIG. 4 shows a method for automatic vehicle verification using at least one identity feature corresponding to a vehicle, in accordance with one embodiment.

FIG. 5A depicts a method of detection of a known license plate with a template matching analysis method, in accordance with one embodiment.

FIG. 5B, depicts a method of detection of a known license plate using OCR, in accordance with one embodiment.

FIG. 5C depicts a method of detection of a known license plate using a weighted score of the OCR and pattern matching scores and using the weighted score to make a match/no match decision, in accordance with one embodiment.

FIG. 5D depicts a method of detection of a known license plate a logical OR function of the OCR and pattern matching scores, i.e., if at least one of the methods, OCR or pattern matching, detects the license plate, the 5C method detects the license plate, in accordance with one embodiment.

### DETAILED DESCRIPTION

The present disclosure relates to automatic vehicle verification based on at least one identity aspect, i.e., a license plate. A system and method described herein particularly relates to capturing a vehicle image using the user's smart device, detecting a portion containing an identity aspect from the captured image, processing the portion for recognizing the identity aspect using recognition techniques, e.g., Optical Character Recognition (OCR), and verifying the vehicle by comparing the identity aspect with prestored identity aspect corresponding to the vehicle, in accordance with one embodiment.

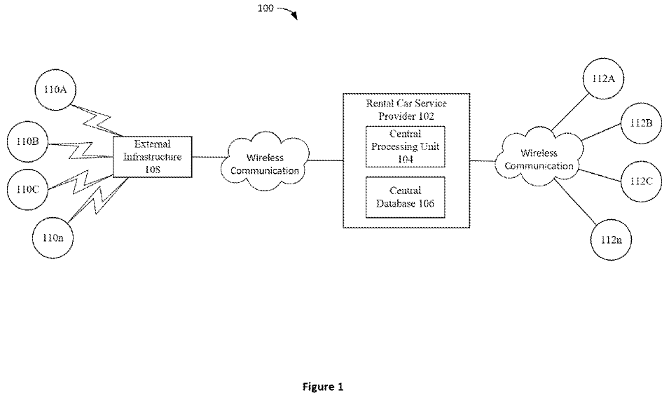

FIG. 1 is a system 100 for an exemplary rented car service (RCS) 102 present in the prior art. Typically, the system directs to an exemplary vehicular video-based data capture and analysis techniques. The system includes a central processing unit 104 and a central database 106. The central processing unit 104 may include one or more processors to execute programmable instructions. The central database 106 is coupled to the central processing unit 104 and stores all identity related aspects corresponding to each vehicle, 110A, 110B . . . 110n, deployed on the service. All vehicles are collectively referred to as vehicle 110. One example of the identity aspects includes license plates. The central database 106 may store identification aspects related to each user and information regarding allotted vehicle 110 to the user. The system may be bidirectionally coupled to the user device to communicate information, such as personal identification or vehicle allotment, to the user.

In one implementation, the system may employ an external infrastructure 108, e.g., traffic surveillance cameras, parking surveillance cameras and the like, to capture video or images of the vehicle 110. In another implementation, the user's device 112, such as a smartphone, may be implemented to capture images or videos of the vehicle 110. The user devices 112 and the external infrastructure 108 may be connected to the system 100 over a wireless communication network, in one embodiment.

The system of the prior art requires the captured data to be transmitted to the central processing unit over a wireless communication network. The captured images may be processed to detect identity related aspects, but as surveillance cameras are fixed, there is a possibility that the cameras may fail to capture the image at desired angle resulting in wrong or poor recognition. Moreover, the data transmitted to the central processing unit is compared with the entire data stored in the central database till the match is found, which may result in a time and resource consuming process. The effective and quick recognition of the vehicle without any dependency on the wired or wireless communication network is the main drawback of the prior art.

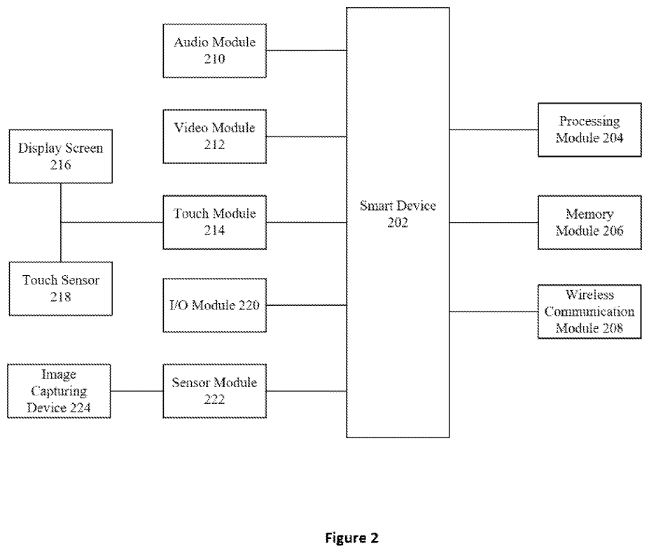

In accordance with one embodiment, the system is implemented on a user's device, e.g., smart device 202. FIG. 2 is a block diagram of the smart device 202 with a functional component, in accordance with one embodiment. In one embodiment, the smart device 202 includes a mobile device, such as an Apple iOS based device, including iPhones, iPads, or iPods, or an Android based device, like a Samsung Galaxy smartphone, a tablet, or the like. The mobile device includes an application program or app running on a processor. In one implementation, the system may be a web-based system accessed by the smart device 202.

The smart device 202 includes a processing module 204 connected to a data bus and to a memory module 206 and additional functional modules. In one embodiment, the processing module 204 can be Qualcomm Snapdragon, or such Qualcomm's Snapdragon processors, ARM Cortex A8/9 processors, Nvidia's Tegra processors, Texas Instruments OMAP processors, or the like. The processing module 204 executes operating system software, such as Linux, Android, iOS, or the like, firmware, drivers, and application software.

The smart device 202 further includes a wireless communication module 208, an audio module 210, a video module 212, a touch module 214, a sensor module 222, and an I/O module 220. In this embodiment, the different modules are implemented as hardware module, software module, or a combination thereof. In one implementation, the processing module 204 may be a central processor (“CPU”) on an SoC also including a multimedia processor, wireless modem, signal co-processors, such as for example, one or more vision processing module 204 (“VPU”), one or more graphics processor unit (“GPU”) cores, and/or one or more holographic processing module 204 (“HPU”) cores. In one implementation, one or more SoC processors may encompass. CPUs, GPUs, VPUs, HPUs, and other co-processors, camera 224 modules, screen controllers, memory controllers, sound chipsets, motherboard buses, and on-board memory, and several peripheral devices, including for example cellular, Wi-Fi, and Bluetooth transceivers, as further described below. Another embodiment may include modules as discrete components on a circuit board interconnected by bus or a combination of discrete components and one or more SoC modules with at least some of the functional modules built in.

The wireless communication module 208, in one embodiment, may be configured to implement the system on the smart device 202. The wireless communication module 208 may include a cellular modem, e.g., compliant with 3G/UMTS, 4G/LTE, 5G or similar wireless cellular standards, a Wi-Fi transceiver, e.g., compliant with IEEE 802.11 standards or similar wireless local area networking standards, and a Bluetooth transceiver, e.g., compliant with the IEEE 802.15 standards or similar short-range wireless communication standards. In one embodiment, the wireless transceiver module 205 is a Sierra Wireless HL-7588.

The audio module 210, in one embodiment, may be configured to receive or transmit audio input or output, for example, voice activation services or audio of a vehicle's video being recorded for verification purpose. The audio module 210 may include an audio codec chipset with one or more analog and/or digital audio input and output ports and one or more digital-to-analog converters and analog-to-digital converters and may include one or more filters, sample rate converters, mixers, multiplexers, and the like. For example, in one embodiment, a Qualcomm WCD9326 chipset is used, but alternative audio codecs may be used.

In one embodiment, the video module 212 may be configured to capture video of the vehicle passing through or parked within the perimeter. The captured video may be processed to extract a frame with a clear view of a portion of the vehicle indicative of at least one identity aspect. The video module 212 may include a DSP core for video image processing with video accelerator hardware for processing various video compression formats and standards, including for example, MPEG-2, MPEG-4, H.264, H.265, and the like. In one embodiment, video module 212 may be integrated into an SoC “multimedia processor” along with processing module 204. For example, smart device 202 may include an integrated GPU inside the Qualcomm MSM8953.

In one embodiment, the touchscreen module may be configured to operate the system, for vehicle verification, using a touchscreen of the smart device 202. The touch module 214 may include a low-power touchscreen sensor 218 integrated circuit with a capacitive touchscreen controller as is known in the art. The touch module 214 may be implemented with different components, such as single touch sensor 218 and multi-touch sensor 218. In one embodiment, the touch module 214 includes an LCD controller for controlling video output to the smart device 202's LCD screen, i.e., display screen 216. The LCD controller may be integrated into a touch module 214 or may be provided as a separate module on its own or distributed among various other modules. Touchscreen may be utilized as other input devices, such as a keyboard, mouse, stylus, or the like. In addition, user input may be received through one or more microphones. Smart device 202 may also include one or more audio output devices, such as speakers or speaker arrays. In alternative embodiments, audio output devices may include other components, such as an automotive speaker system, headphones, stand-alone “smart” speakers, or the like.

Smart device 202 may also include a sensor module 222 configured to sense one or more input relevant to the operation of the smart device 202. For example, to capture a video or images of the vehicle. The sensor module 222 may also include image capturing device 224, such as cameras. In one embodiment, the camera 224 may be a high-definition CMOS-based imaging sensor camera 224 capable of recording video one or more video modes, including for example high-definition formats, such as 1440p, 1080p, 720p, and/or ultra-high-definition formats, such as 2K (e.g., 2048×1080 or similar), 4K or 2160p, 2540p, 4000p, 8K or 4320p, or similar video modes. Camera 224 may record video using variable frame rates, such for example, frame rates between 1 and 300 frames per second. For example, in one embodiment, camera 224 is the Omnivision OV-4688 camera. Alternative camera 224 may be provided in different embodiments capable of recording video in any combinations of these and other video modes. For example, other CMOS sensors or CCD image sensors may be used. Camera 224 may be controlled by the video module 212 to record video input. A single smart device 202 may include multiple cameras 224 to cover different views and angles. For example, in a vehicle-based system, smart device 202 may include a camera 224 located in different parts of the vehicle, e.g., a front camera 224, a side camera 224, a back camera 224, and an inside camera 224.

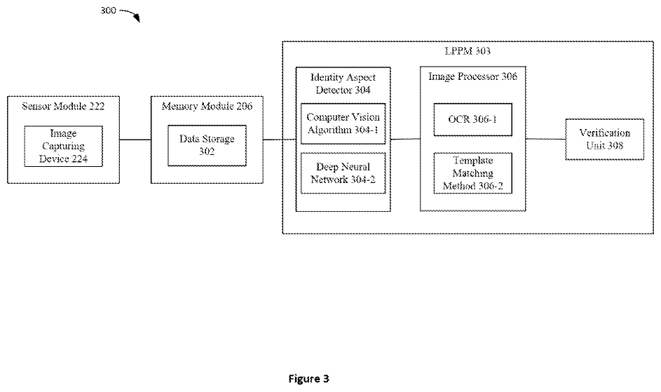

FIG. 3 is a block diagram of a system implemented on the smart device 202 for automatic vehicle verification, in accordance with one embodiment. All components of FIG. 3 should be read in view of FIG. 2. The system is configured to perform automatic vehicle verification based on at least one identity aspect of the vehicle using image processing techniques as described herein. The vehicle may be a car, a scooter, a bicycle, or any such ground driven automobile. The identity aspect is a feature that can specifically identify the vehicle in question. In one implementation, the identity aspects may be in human-readable format, such as a license plate. In another implementation, the identity aspect may be in machine-readable format, such as a barcode or a quick response (QR) code.

As described earlier, the system is implemented on a smart device 202. In one implementation, the user may have to install the system, e.g., a mobile application, on their smart device 202. The user may have to login into the system before starting the ride, furnish their identity details, for example, driving license details, and receive a vehicle's allotment details. In one implementation, if the user is allotted with a scooter A having a license plate number CL27A45, all details of the vehicle including the license plate number CL27A45, insurance details of the vehicle, registration details of the vehicle and other relevant details, may be furnished by the system on the mobile application and can be accessed by the user. As it can be understood by a person skilled in the art, the known identity aspect related to only allotted vehicles will be available to the user to access and utilize for the vehicle verification process. No details related to other vehicles will be fetched and stored in the user's application.

The system mainly includes, but may not be limited to, the sensor module 222, the memory module 206, an image capturing device 304, an image processor 306, and a verification unit 308, according to one embodiment. The sensor module 222, as described in FIG. 2 may be configured to sense one or more inputs. Particularly, in view of the system, the sensor module 222 implements an image capturing device 224, referred to as camera 224 hereinafter. The camera 224, according to one aspect of the embodiment, is integrated with the smart device 202. The camera 224 is configured, when the user is prompted, to capture an image of at least a portion of the vehicle, wherein the portion includes at least one identity aspect of the vehicle. In one example, a car may have a license plate embedded on the rear portion. In another example, a scooter may have a license plate embedded at a front portion, preferably below a headlamp. In yet another example, a car may have a QR code imprinted on either door. In yet another example, a scooter may have a barcode imprinted at the front portion right below the headlamp. In one implementation, a user may be prompted to use the camera 224 integrated with his smart device 202 to capture a real-time video. In another implementation, a user may be prompted to use the camera 224 integrated with his smart device 202 to capture a series of images of the vehicle.

According to one aspect of the embodiment, the captured images or videos are stored in a data storage 302 and at least one known identity aspect of the vehicle. In one implementation, the data storage 302 may be a part of memory module 206 of the smart device 202. The memory module 206 may be a random-access memory (“RAM”) for temporary storage of information, one or more read only memory (“ROM”) for permanent storage of information, and one or more mass storage device, such as a hard drive, diskette, solid state drive, or optical media storage device. In one implementation, the data storage 302 may be a part of an internal memory of the smartphone. In another implementation, the data storage 302 may be a part of an external memory.

Referring to the parking of the vehicle and ending the trip, in one example, the user may wish to park a vehicle in a public parking location, which may not be an official parking of a rental car service or micro mobility service provider. Once the vehicle is parked, the user may initiate the system, and get prompted to capture the image or video. The user may capture one or more images, where each image may have one or more identity aspects of the vehicles. All captured data may be stored in the data storage 302.

Furthermore, the data storage 302, in one embodiment, may also store data related to one or more known identity aspects related to the vehicle. For example, when a vehicle is registered with the rental services, all identity aspects of that vehicle must be captured and stored in a central database (not shown in the Figure) of the system. In essence, all vehicles have their respective known identity aspects stored with the system.

Now referring to FIG. 3, the data storage 302 is a local storage, subject to the smart device 202. Therefore, instead of loading all data of all vehicles registered with the service, the system preloads the data related only to the vehicle allotted to the user. Data related to the known identity aspects of the vehicle is stored in the data storage 302 subsequent to the vehicle allotment to the user.

In accordance with one embodiment, the system further includes a license plate processing and matching component (LPPM) 303 implemented to identify the identity aspect from the captured image, process the image for enhancement, perform analysis to recognize characters representing the identity aspect, and verify the vehicle identity by matching the characters of the identity aspect with characters of the known identity aspects. The LPPM 303 comprises an identity aspect detector 304, the image processor 306, and the verification unit 308.

According to the further aspect of the embodiment, the system includes the identity aspect detector 304 to detect at least one identity aspect of the vehicle from the captured vehicle image. The identity aspect may form one portion of visual data, e.g., a vehicle image captured by the user.

The identity aspect detector 304 is configured to detect the portion indicative of the identity aspect. Particularly, the one or more known data parameters, such as rectangular plate having corners, contrast color combination, alphanumeric data context and such other details are provided to the identity aspect detector 304, which may implement one or more image processing techniques to segregate only relevant data, such as data related to the identity aspect, from the entire image. In one implementation, one technique may be a computer vision algorithm 304-1. In another implementation, one technique for identity aspect identification may be a deep neural network 304-2.

Computer vision is the process of perceiving, analyzing, understanding, and/or interpreting imagery data. Such imagery data may be a combination of videos, images, real-time or near real-time data captured by any type of camera 224 or video recording device. Object recognition from such data can be regarded as a high-level process performed by the computer vision algorithm 304-1s. For example, the system can implement real-time object detection algorithms to detect barcodes, QR codes, license plates or any other vehicle identity aspect based on visual data captured by the camera 224 of the smart device 202.

Computer vision algorithm 304-1 can extract the specific features (such as edges, corners, color) that are relevant to the identity aspects. The computer vision approach may include an object detector, which performs feature detection based on heuristics hand-tuned by human engineers. Pattern-recognition tasks typically use an initial-stage feature extraction stage, followed by a classifier.

Classic computer vision follows a rules-based approach, and therefore, for exact detection of the object/identity aspect, a set of expressed and programmed decision guidelines, intended to cover all possible representations of the identity aspects must be provided. For example, shapes of corners and dimensions of the license plate, color, fading and shadow effects, and such details must be preprogrammed into the system. For example, the high contrast between the background and letters of the license plate (designed as so to make the letters more readable), the specific background color or the straight lines that encompass it can be detected. With this method we extract a mask of the license plate.

In accordance with one embodiment, the at least one identity aspect is detected by a self-learning algorithm or human-assisted learning algorithms. A Deep Neural network 304-2s may be trained and implemented to detect the identity aspect from the visual data. Neural network 304-2s are widely viewed as an alternative approach to the computer vision algorithm 304-1s. Neural networks 304-2 are typically trained with training data collected in similar environments. Neural networks 304-2, in one example, may be implemented on massively parallel graphics processing module (“GPUs”), tremendously accelerating learning and inference ability. While a processing module 204 typically consists of a few cores optimized for sequential serial processing. more efficient computing cores designed for handling multiple tasks simultaneously. GPUs are used for many purposes beyond graphics, including to accelerate high performance computing, deep learning and artificial intelligence, analytics, and other engineering applications. GPUs are ideal for deep learning and neural networks 304-2. GPUs perform many simultaneous calculations, cutting the time that it takes to train neural network 304-2s.

With deep learning, a neural network 304-2 learns many levels of abstraction. They range from simple concepts to complex ones. Each layer categorizes information. It then refines it and passes it along to the next. Deep learning stacks the layers, allowing the machine to learn a “hierarchical representation.” For example, the first layer looks for vertical or horizontal lines of the license plate. The next layers look for the intersections of vertical and horizontal lines, going from general to specific features.

The image processor mainly processes the captured vehicle image, identifies at least one area of the captured vehicle image that is indicative of the at least one identity aspect, and converts the content of the at least one area into a machine-readable format. The image processor 306 is configured to receive the portion of the captured images from the image capturing device 304 in order to process the images for effective recognition. The image processor 306 may be operated by the processing module 204 of the smart device 202. The portion of the captured image of the vehicle, in one example, is resized, enhanced, and/or otherwise modified, and then passed to the processing module 204.

The image processor 306 may employ one or more methods for enhanced and quick content detection of the identity aspects of the vehicle. One such method is Optical Character Recognition (OCR 306-1), according to one embodiment, which can be used to obtain all or portions of the captured visual data. OCR 306-1 offers automating data extraction from printed or written text or visual images, and the converting the object or the text into a machine-readable form to be used for data processing like editing or searching.

The image processor 304 may process each captured image to obtain the identity aspect of the vehicle and associated confidence values, based on OCR 306-1. The OCR 306-1 is typically configured to function based on training data and to perform license plate recognition. For training purposes, the OCR 306-1 receives a plurality of the training images. All images are pre-processed for identification of the portion, corrected for errors, edited for clarity of the images and reduced further to segmentation and feature extraction. The segmentation and feature extraction can be done by one or more methods applied on the visual data. The OCR 306-1 module may be informed with one or more details related to the known identity aspects. For example, edges forming a border, edges forming angles and such data is provided to the OCR 306-1 module as an input. Trained OCR 306-1 module may temporarily store the files. A new image may be captured, pre-processed, and performed for segmentation and feature extraction. New data, in real-time, can be provided for recognition. The data related to the new image captured and the training data, or in current case, pre-stored data, such as structural aspects of the license plate, are compared, and upon finding a match, the new image is said to be recognized.

In one implementation, the OCR 306-1 module may include a string correlation module parsing through the available OCR 306-1 results and identifying common patterns between them using the string correlation approach. The common patterns can be defined to be sub-strings with at least some matching characters between them, which are bounded by matching characters. The strings can slide past one another location by location and the number of matching characters between the codes can be recorded at each index value. Using the correlation information, the index (offset) value which provides a most common element between the strings can be identified. As the OCR 306-1 recognizes patterns and symbols of the characters, the OCR 306-1 may be implemented without restricting to any particular language.

Typically, OCR 306-1 results may lead to ambiguity due to similarity in structures of the characters. For example, “B” vs “8”, “Z” vs. “2” ambiguity can be caused. For example, consider a NY license plate with real code “ABC1234”, but as a result of “A8C1234”. Here the “B” can be mistaken for an “8” and the plate code is highly unlikely. Thus, the state identification module can have an extremely low confidence for the result. This low confidence score is mainly a result of comparing the new data with the entire database related to the known identity aspect. As it can be understood by a person skilled in the art, more characters or data obtained for comparison against the new data, will result in a lower confidence score. Therefore, according to the one embodiment, the data storage 302 is stored with the data related to the known identity aspects of the only vehicle that has been allotted to the user, and not of the other vehicles. As there is hardly one character string to compare the character string of the portion of the captured vehicle image against, the OCR 306-1 results may be of high-confidence value.

In one embodiment, the image processor 306 may include a template matching process for identity aspect recognition. The template matching 306-2 is a technique in digital image processing for finding small parts of an image which match a template image. In an implementation, the template image may be indicative of the known identity aspects, such as a license plate of the vehicle. The template image may be specific to each vehicle, and therefore, the specific template may be retrieved and provided on the system, following the user login and vehicle allotment. The template image related only to the allotted vehicle may be provided on the application. The image processor 306 may find small parts on the template image and compare those with the new image to find similarity. If the parts are matching, the new image can be recognized.

In accordance with one embodiment, the verification unit is configured to verify the vehicle based on the comparison carried out between the at least one identity aspect with the at least one known identity aspect of the vehicle. The verification is carried out on the smart device 202 in real-time without a wireless network.

The system is operated on the smart device 202, without requiring transmitting the data or images, renders the system robust and secured over the prior arts. The aspect of OCR 306-1 technique is being applied on only data related to the vehicle and compared against new images, which reduces the possibility of low-confidence score, rendering the system more accurate and effective.

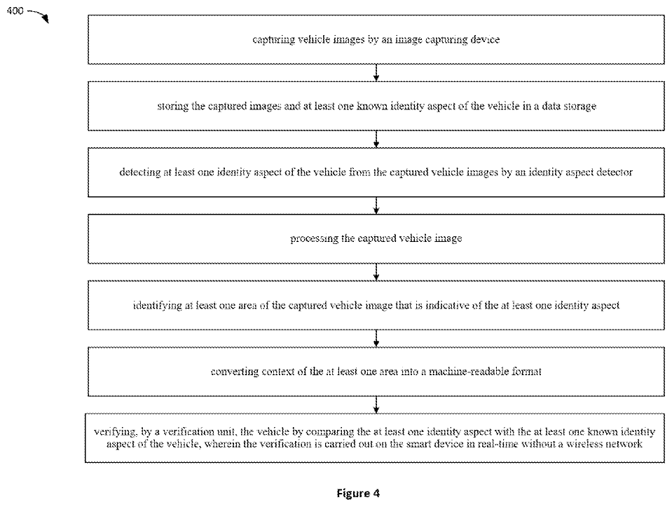

FIG. 4 shows a method 400 for automatic vehicle verification using at least one identity feature corresponding to a vehicle, implemented on a smart device 202. The verification method is based upon the character strings generated by the OCR 306-1 of the image processor 306. The character string is compared with a character string of the known identity aspect to find a match. If the match is found, the vehicle is recognized. If not, the user is prompted to initiate the image capturing process again to perform the next iteration of the vehicle recognition process.

The smart device 202 is operated by a user of a vehicle to whom the vehicle has been rented. The system components performing the method steps are implemented on the smart device 202. The method mainly captures the vehicle images, performs vehicle recognition using analysis techniques, such as OCR 306-1, and verifies the vehicle independent of any communication network.

The method step 402 includes capturing vehicle images by an image capturing device 224. The image capturing device 224 may capture a real-time video stream, in one implementation. An image frame is extracted from the video stream for image processing in order to recognize the vehicle from the image.

The method step 404 includes storing the captured images and at least one known identity aspect of the vehicle in a data storage 302. The data storage 302 is a local storage of the smart device 202, in one implementation.

The method step 406 includes detecting at least one identity aspect of the vehicle from the captured vehicle images by an image capturing device 304.

The method step 408 includes processing the captured vehicle image.

The method step 410 includes identifying at least one area of the captured vehicle image that is indicative of the at least one identity aspect.

The method step 412 includes converting content of the at least one area into a machine-readable format.

The method step 414 includes verifying, by a verification unit, the vehicle by comparing the at least one identity aspect with the at least one known identity aspect of the vehicle, wherein the verification is carried out on the smart device 202 in real-time without a wireless network.

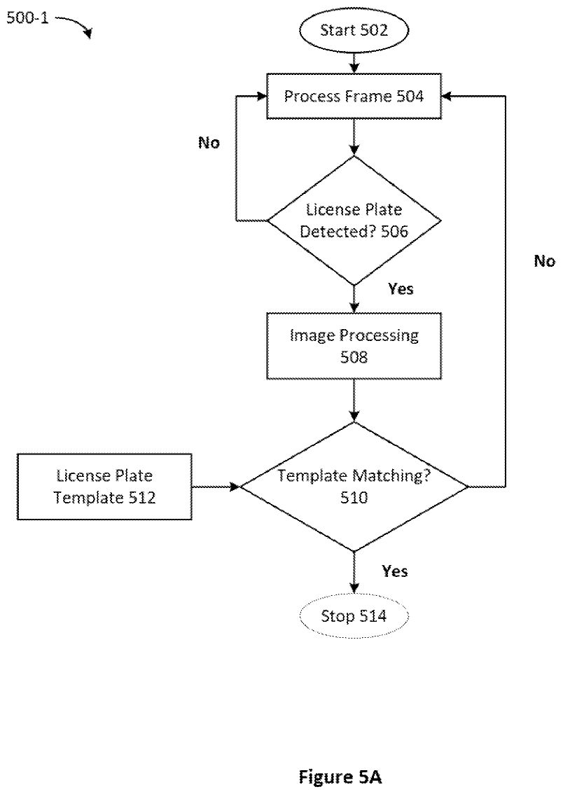

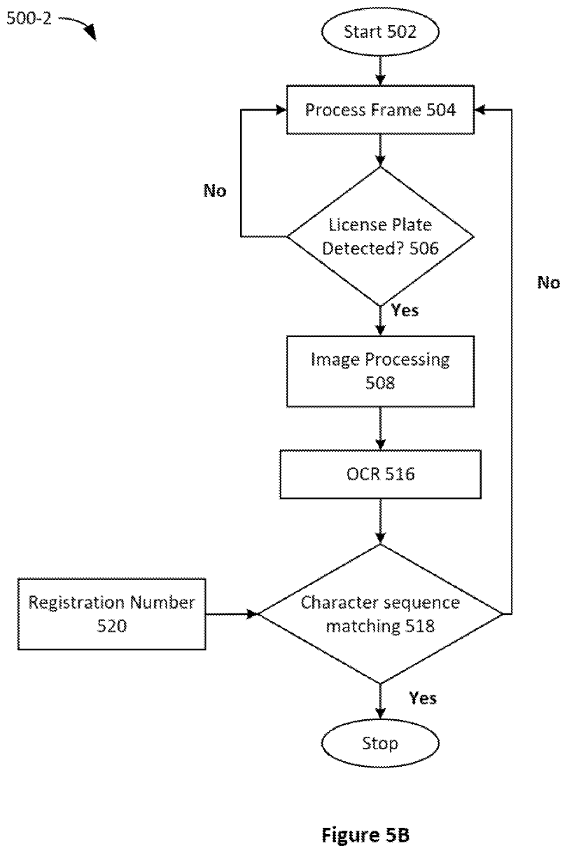

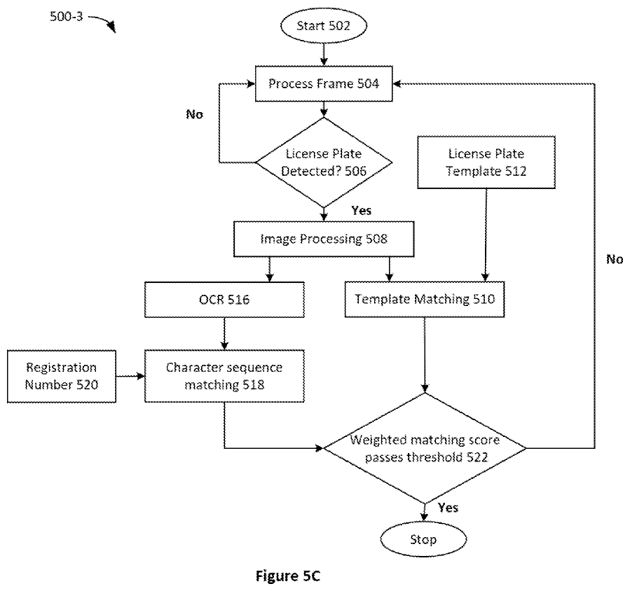

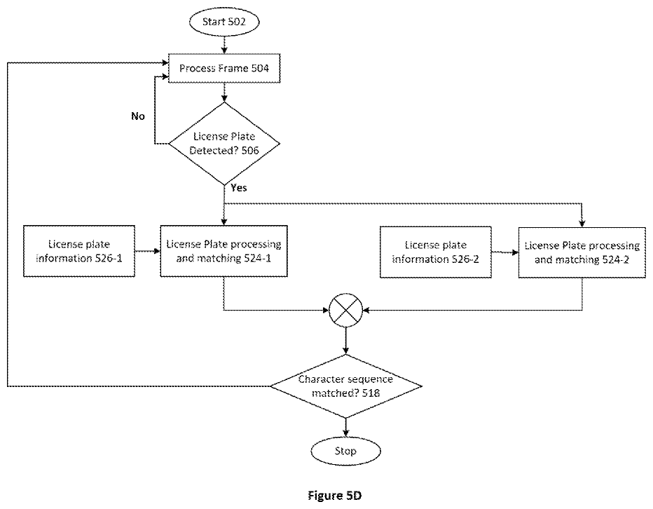

FIGS. 5A-5D depict flow diagrams of different implementations of the system, in accordance with embodiments.

FIG. 5A depicts a method of detection of a known license plate with a template matching analysis 306-2. As discussed earlier, the frame of the captured video or the image is pre-processed to enhance the visual data for image processing. At block 504, a frame obtained from the real-time video or image taken by the user is processed.

The frame is processed for identifying the presence of the identity aspect of the vehicle at block 506. If the frame contains at least one identity aspect, such as a license plate, the frame is sent for image processing 508. If no identity aspect is detected, the user is prompted to capture another image, or the method moves to the next video frame in the Process Frame 504 step.

The frame may include one or more portions or areas indicative of the identity aspect. Each portion is processed to determine the presence of the identity aspect till the identity aspect is found. The method steps will be repeated till the last portion of the frame.

If Template Matching 510 determines that the identity aspect on the frame does not match the License Plate Template 512, the user is prompted to capture another image or the method moves to the next video frame, in accordance with embodiment.

At block 508, the portion of the captured image which indicates the identity aspect detection, is processed, enhanced, and analyzed against the known identity aspects. The image processor 306 may be provided with the data related only to the vehicle allotted to the user. The characters from the portion of the frame determined to contain the identity aspect are extracted by OCR 306-1 and compared with the processed portion of the images. In view with the known identity aspects, a template based on the known identity aspects may be provided by the application for the user to verify the vehicle. The template may be constructed of a small part, all or some of the parts are compared with the portion of the processed frame determined to contain the identity aspect. The template matching module 510 is provided with a license plate template 512 which provides a license plate to match the new portion of the frame determined to contain the identity aspect.

FIG. 5B depicts a method of detection of a known license plate using OCR 306-1, according to one embodiment. As discussed earlier, the frame of the captured video or image is pre-processed to enhance the visual data for image processing. At block 504, a frame obtained from the real-time video or image taken by the user is processed. The frame is processed for identifying the presence of the identity aspect of the vehicle at block 506. If the frame contains at least one identity aspect, such as a license plate, the frame is sent for image processing. If no identity aspect is detected, the user is prompted to capture another image, or the method moves to the next video frame

As a person skilled in the art would understand, the frame may include one or more portions or areas indicative of the identity aspect. Each portion is processed to determine the presence of the identity aspect till the identity aspect is found. The method steps will be repeated till the last portion of the frame. Upon failure of detection of the identity aspect, the user is prompted to capture another image, or the method moves to the next video frame, in accordance with embodiment.

At block 516, OCR 306-1 method is implemented. As described earlier, the OCR 306-1 is implemented to recognize characters contained in the portion of the frame determined to contain the identity aspect. Each character or a character string may be compared with the characters of the identity aspects, such as registration number of the vehicle, or known license template to perform recognition. If the characters match, the OCR 306-1 result is considered as vehicle recognized. If the characters do not match, the method is repeated with a new frame.

FIG. 5C depicts a method of detection of a known license plate using a weighted matching score based on the scores provided by the Character sequence matching 518 score using the OCR 516 output and the Template Matching 510 score, according to one embodiment. As discussed earlier, the captured frame of the video or image is pre-processed to enhance the visual data for image processing.

At block 504, a frame obtained from the real-time video or image taken by the user is processed. The frame is processed for identifying the presence of an identity aspect of the vehicle at block 506. If the frame contains at least one identity aspect, such as a license plate, the frame is sent for image processing 508. If no identity aspect is detected within the frame, the user is prompted to capture another image, or the method moves to the next video frame.

As a person skilled in the art would understand, the frame may include one or more portions or areas indicative of the identity aspect. Each portion is processed to determine the presence of the identity aspect till the identity aspect is found. The method steps will be repeated till the last portion of the frame. Upon failure of detection of the identity aspect, the user is prompted to capture another image, or the method moves to the next video frame, in accordance with embodiment.

At block 508, the image processing employs an OCR 306-1 and the template matching analysis method 306-2. OCR 306-1 is performed at block 516. Character strings are extracted from the frame and sent to a character sequence matching unit 518 where character sequence or character strings of the processed frame are matched with the character sequence or strings of the known identity aspect. The character sequence matching module 518 received a registration number 520 of the vehicle currently allotted to the user. A result of character recognition is provided to the weighted matching score having a predetermined threshold, at 522. Value of a matching score may be compared with the threshold and if the value exceeds the threshold, the vehicle recognition process can be completed. The image processor 306, along with OCR 306-1, may implement the template matching module 306-2, at block 510 for recognizing the identity aspects of the vehicle. The template matching module 306-2, at block 510, receives the license plate template 512. Based on the license template, the template matching 306-2 is performed. If the templates are matched, the result is sent to the weighted matching score block 522 to verify the score. If the score of the template matching method 306-2 exceeds the weighted matching score threshold, the vehicle is recognized, if not, then the user may be prompted to take another image or video.

FIG. 5D depicts a method of detection of multiple identifying aspects of the vehicle on one vehicle, e.g., a license plate and a QR code using two different matching methods 524-1 and 524-2, according to one embodiment. If at least one of the methods 524-1 or 524-2 detects a matching identifying aspect, the method according to FIG. 5D considers the license plate matched.

As discussed earlier, the frame of the captured video or image is pre-processed to enhance the visual data for image processing. At block 504, a frame obtained from the real-time video or image taken by the user is processed. The frame is processed for identifying the presence of the identity aspect of the vehicle at block 506. If the frame contains at least one identity aspect, such as a license plate, the frame is sent for image processing. If no identity aspect is detected, the user is prompted to capture another image, or the method moves to the next video frame

The frame may include one or more portions or areas indicative of the identity aspect. Each portion is processed to determine the presence of the identity aspect till the identity aspect is found. The method steps will be repeated till the last portion of the frame. Upon failure of detection of the identity aspect, the user is prompted to capture another image, or the method moves to the next video frame, in accordance with embodiment.

As discussed earlier, the image or frame may contain one or more portions that may represent identity aspects. Each portion is considered for image processing the matching operations, as shown in the Figure. In exemplary implementation, at block 524-1, license plate processing and matching operations may be performed on the first portion of the frame representing a first identity aspect, for example, a license plate, and the matching will be performed based on the license plate information 526-1 corresponding to the first identity aspect. In the same exemplary implementation, the vehicle recognition method fails at this stage; a second portion of the image may be processed in order to verify the vehicle. Second portion of the image may represent a second identity aspect, such as a QR code corresponding to the license plate. At block 542-3, license plate processing and matching may be performed on the second identity aspect and may be compared with license plate information 526-2 corresponding to the second identity aspect. Each portion may be considered to perform the vehicle recognition task till the vehicle is recognized. If no portion is adequate to be processed for recognition, the user may be prompted to capture another image or video.

1. The method, for automatic vehicle verification using at least one identity aspect corresponding to a vehicle, implemented on a smart device, comprises:
a. capturing vehicle images by an image capturing device;
b. storing the captured images and at least one known identity aspect of the vehicle in a data storage;
c. identifying at least one area of the captured vehicle image that is indicative of the at least one identity aspect; and
d. verifying, by a verification unit, the vehicle by comparing the at least one identity aspect with the at least one known identity aspect of the vehicle, wherein the verification is carried out on the smart device in real-time capable of working without a wireless network.

2. The method of claim 1, wherein the step of verifying further comprises verifying the vehicle by comparing character sequence of the at least one identity aspect with character sequence of the at least one known identity aspect stored in the data storage.

3. The method of claim 1, wherein the step of verifying the vehicle further comprises determining a weighted matching score.

4. The method of claim 1, wherein the step of identifying further comprises processing a plurality of areas indicating a plurality of identity aspects for verification of the vehicle.

5. A system, for automatic vehicle verification using at least one identity aspect corresponding to the vehicle, implemented on a smart device, the system comprising:
a. an image capturing device, integrated with the smart device, to capture an image of at least a portion of the vehicle, where in the portion includes at least one identity aspect of the vehicle;
b. a data storage to store the captured images and at least one known identity aspect of the vehicle; and
c. License Plate Processing and Matching Component, to perform image processing and matching, comprising:
an identity aspect detector to detect at least one portion of the captured vehicle image, wherein the at least one portion is indicative of the at least one identity aspect of the vehicle;
an image processor, to implement optical characters recognition (OCR) method, configured to:
process the captured vehicle image,
analyze the at least one portion to identity a character string including characters and symbols representing the at least one identity aspect, and,
convert the character string into a machine-readable format; and
verification unit to verify the vehicle by comparing the machine-readable character string with a character strong of the at least one known identity aspect of the vehicle, wherein the verification is carried out on the smart device in real-time without a wireless network.

6. The system of claim 5, wherein the identity aspect is a license plate in human readable format that can be converted into a machine-readable format.

7. The system of claim 5, wherein the identity aspect is a barcode or a quick response (QR) code in a machine-readable format.

8. The system of claim 5, wherein the image processing is based on a template matching technique.

9. The system of claim 5, wherein the at least one identity aspect is detected by a self-learning algorithm or human-assisted learning algorithms.

10. The system of claim 5, wherein the at least one identity aspect is detected by a detection module that identifies a plurality of areas indicating presence of the at least one identity aspect, wherein each of the plurality of areas is processed until the identification aspect is verified.

11. The system of claim 10, if all the plurality of areas are processed and vehicle verification is failed, the system is configured to prompt a user to capture a second image of the vehicle, and wherein the second image is processed for vehicle verification.

12. The system of claim 5, wherein the captured vehicle's image is a frame from a real-time video stream.

13. The system of claim 5, wherein the image processing comprises an image correction, an image editing, an image rotating, or a combination thereof.

14. The system of claim 5, wherein the identity aspect detector is based on a classical computer vision algorithm or a deep learning algorithm.

15. The system of claim 14, wherein the deep learning algorithm is configured to detect the shape of a plate representing the at least one identity aspect, a border confining the at least one identity aspect, a plurality of corners of the shapes or the border.

16. The system of claim 5, wherein the system is configured to pre-store shapes, borders, plates of the at least one known identity aspect into the data storage.

17. The system of claim 5, wherein the comparison between the at least one identity aspect and the at least one known identity aspect is considered based on a confidence score indicative of a probability of correct recognition of confusing characters.
